(19) United States
(12) Patent Application Publication
(10) Pub. No.: US 2024/0204371 A1
(43) Pub. Date: Jun. 20, 2024

(54) CYLINDRICAL BATTERY CELL, BATTERY AND METHOD FOR FORMING CYLINDRICAL BATTERY CELL

(71) Applicant: HEFEI GOTION HIGH-TECH POWER ENERGY CO., LTD., Hefei, Anhui (CN)

(72) Inventors: Azad DARBANDI, Gottingen (DE); Tobias SCHMIEG, Gottingen (DE); Qian CHENG, Hefei, Anhui (CN); Chen LI, Hefei, Anhui (CN)

(21) Appl. No.: 18/287,179

(22) PCT Filed: Jun. 28, 2021
(86) PCT No.: PCT/CN2021/102705

§ 371 Date: Oct. 16, 2023

(51) Int. Cl. H01M 50/536; H01M 10/04; H01M 50/107; H01M 50/119; H01M 50/534; H01M 50/538

(52) U.S. Cl. CPC H01M 50/536; H01M 10/0422; H01M 10/0431; H01M 50/107; H01M 50/119; H01M 50/534; H01M 50/538; H01M 2200/101

(57) ABSTRACT

A cylindrical battery cell, a battery and a method for forming cylindrical battery cell are provided.

In the cylindrical cell, an opening is created on a bottom side of the cell housing and a copper plate is forged with the cell housing to form a bi-metal plate on the bottom side of the cell housing, and the copper plate is welded with the jellyroll structure. Therefore, joining/welding the cell housing with the jellyroll structure is achieved by using a laser from outside of the cell housing, while risk of corrosion of cell housing is not introduced.

### CROSS REFERENCE TO RELATED APPLICATION(S)

The present disclosure is a national stage application of International Patent Application No. PCT/CN2021/102705, which is filed on Jun. 28, 2021 and entitled “Cylindrical battery cell, Battery and Method for forming cylindrical battery cell”, the disclosure of which is hereby incorporated by reference in its entirety.

### TECHNICAL FIELD

Embodiments of the present disclosure generally relate to the field of battery, and more particularly, to a cylindrical battery cell, a battery and a method for forming cylindrical battery cell.

### BACKGROUND

A battery (such as an automotive battery) in general includes a plurality of battery cell. As a kind of battery cell, a cylindrical battery cell is used recently. For example, form factors of the cylindrical battery cell may be from 21700 (diameter is 21 mm and height is 700 mm) to 50120 (diameter is 50 mm and height is 120 mm), and the cylindrical battery cell may at least include a cell housing and a jellyroll structure.

In general, the cylindrical battery cell needs to have a special current path within a cell design in order to ensure enough ampacity. Hence a resistive spot welding of an anode current collector to a steel cell housing is not applicable for larger cell sizes (e.g. 4680 or larger). In some schemes, it is suggested to join a copper current collector and a steel cell housing by long welding seam created by a laser beam or an ultrasonic.

This section introduces aspects that may facilitate a better understanding of the disclosure. Accordingly, the statements of this section are to be read in this light and are not to be understood as admissions about what is in the prior art or what is not in the prior art.

### SUMMARY

However, the inventors found that in some existing schemes, there are several difficulties, challenges and risks in welding copper to steel. For example, copper and steel have quite different melting points (1085° C. vs. 1450° C.). Almost 400° C. difference in melting point makes a proper adjustment of laser beam intensity rather challenging. Furthermore, joining/welding can be only achieved, in case a laser beam hits a copper surface. This means, the joining of a cell housing and a copper current collector cannot be performed from outside of the cell housing. Furthermore, welding of Cu and Nickel-Plated Steel can affect Nickel coating, which potentially introduce risk of corrosion of cell housing, which in terms may potentially lead to cell internal short circuit by transportation of corrosion products.

In order to solve at least part of the above problems, methods and devices are provided in the present disclosure. Features and advantages of embodiments of the present disclosure will also be understood from the following description of specific embodiments when read in conjunction with the accompanying drawings, which illustrate, by way of example, the principles of embodiments of the present disclosure.

In general, embodiments of the present disclosure provide a cylindrical battery cell, a battery and a method for forming cylindrical battery cell. It is expected to join/weld the cell housing with the jellyroll structure by using a laser from outside of the cell housing, while risk of corrosion of cell housing is not introduced.

In a first aspect, a cylindrical battery cell is provided. The cylindrical battery cell at least includes a cell housing and a jellyroll structure which is arranged inside the cell housing, an opening is created on a bottom side of the cell housing and a copper plate is forged with the cell housing to form a bi-metal plate on the bottom side of the cell housing, and the copper plate is welded with the jellyroll structure.

In some embodiments, the bi-metal plate is formed to seal the opening, and the copper plate is welded with the jellyroll structure by using a laser via the opening from outside of the cell housing.

In some embodiments, one or more flattened tabs of the jellyroll structure are pre-welded with a copper current collector on a bottom side of the jellyroll structure, and the copper plate is welded with the copper current collector by using a laser after the jellyroll structure is inserted into the cell housing.

In some embodiments, a thickness of the copper plate in the opening is larger than a thickness of the cell housing.

In some embodiments, a thickness of the copper plate in the opening is equal to a thickness of the cell housing, or is smaller than a predetermined threshold.

In some embodiments, one or more flattened tabs of the jellyroll structure are welded with the copper plate by using a laser after the jellyroll structure is inserted into the cell housing.

In some embodiments, a thickness of the copper plate in the opening is equal to a thickness of the cell housing, or is smaller than a predetermined threshold.

In some embodiments, the cell housing is made up of steel, and the bi-metal plate is formed by using a forging process on the bottom side of the cell housing.

In a second aspect, a method for forming cylindrical battery cell is provided. The method includes: creating an opening on a bottom side of a cell housing; inserting a copper plate on the bottom side of the cell housing; forging the copper plate with the cell housing to form a bi-metal plate on the bottom side of the cell housing; and welding the copper plate and a jellyroll structure which is arranged inside the cell housing.

In a third aspect, a battery is provided, the battery comprises a plurality of the cylindrical battery cell according to the first aspect of the embodiments.

According to various embodiments of the present disclosure, an opening is created on a bottom side of the cell housing and a copper plate is forged with the cell housing to form a bi-metal plate on the bottom side of the cell housing, and the copper plate is welded with the jellyroll structure. Therefore, joining/welding the cell housing with the jellyroll structure is achieved by using a laser from outside of the cell housing, while risk of corrosion of cell housing is not introduced.

### BRIEF DESCRIPTION OF THE DRAWINGS

The above and other aspects, features, and benefits of various embodiments of the disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram which shows a cylindrical battery cell in accordance with an embodiment of the present disclosure;

FIG. 2 is another diagram which shows a section view of the cylindrical battery cell in accordance with an embodiment of the present disclosure;

FIG. 3 is another diagram which shows a section view of the cylindrical battery cell in accordance with an embodiment of the present disclosure;

FIG. 4 is another diagram which shows a section view of the cylindrical battery cell in accordance with an embodiment of the present disclosure;

FIG. 5 is another diagram which shows a section view of the cylindrical battery cell in accordance with an embodiment of the present disclosure;

FIG. 6 is a diagram which shows a method for forming cylindrical battery cell in accordance with an embodiment of the present disclosure;

FIG. 7 is a diagram which shows a cell housing with an opening in accordance with an embodiment of the present disclosure;

FIG. 8 is a diagram which shows a cell housing inserting a copper plate in accordance with an embodiment of the present disclosure;

FIG. 9 is a diagram which shows a cell housing forging a copper plate in accordance with an embodiment of the present disclosure;

FIG. 10 is another diagram which shows a cell housing forging a copper plate in accordance with an embodiment of the present disclosure;

FIG. 11 is another diagram which shows a cell housing forging a copper plate in accordance with an embodiment of the present disclosure;

FIG. 12 is a diagram which shows a cell housing welding with a copper plate in accordance with an embodiment of the present disclosure.

### DETAILED DESCRIPTION

The present disclosure will now be described with reference to several example embodiments. It should be understood that these embodiments are discussed only for the purpose of enabling those skilled persons in the art to better understand and thus implement the present disclosure, rather than suggesting any limitations on the scope of the present disclosure.

It should be understood that when an element is referred to as being “connected” or “coupled” or “contacted” to another element, it may be directly connected or coupled or contacted to the other element or intervening elements may be present. In contrast, when an element is referred to as being “directly connected” or “directly coupled” or “directly contacted” to another element, there are no intervening elements present. Other words used to describe the relationship between elements should be interpreted in a like fashion (e.g., “between” versus “directly between”, “adjacent” versus “directly adjacent”, etc.).

As used herein, the terms “first” and “second” refer to different elements. The singular forms “a” and “an” are intended to include the plural forms as well, unless the context clearly indicates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof.

The term “based on” is to be read as “based at least in part on”. The term “cover” is to be read as “at least in part cover”. The term “one embodiment” and “an embodiment” are to be read as “at least one embodiment”. The term “another embodiment” is to be read as “at least one other embodiment”. Other definitions, explicit and implicit, may be included below.

In this disclosure, unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

### A First Aspect of Embodiments

A cylindrical battery cell is provided in the embodiments.

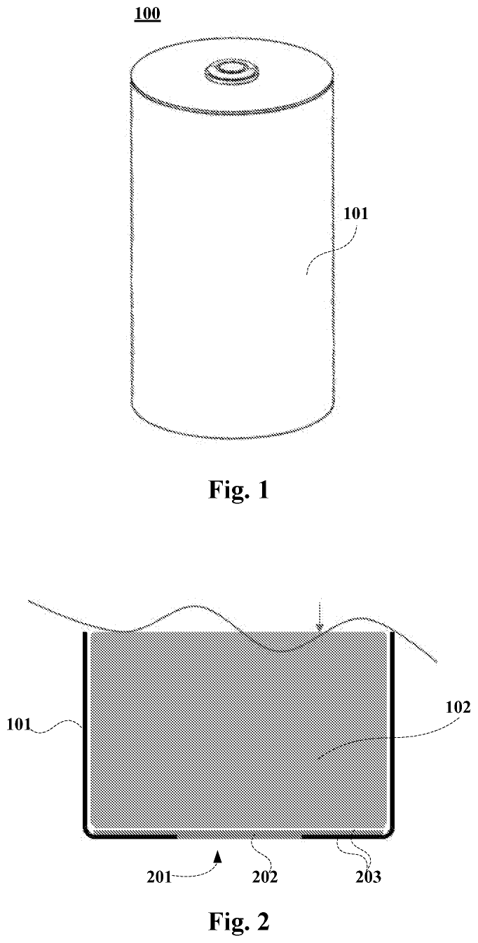

FIG. 1 is a diagram which shows a cylindrical battery cell 100 in accordance with an embodiment of the present disclosure. FIG. 2 is another diagram which shows a section view of the cylindrical battery cell 100 in accordance with an embodiment of the present disclosure.

As shown in FIG. 1 and FIG. 2, a cylindrical battery cell 100 at least includes: a cell housing 101 and a jellyroll structure 102. The jellyroll structure 102 is arranged inside the cell housing 101. For the sake of simplification, only a bottom side of the cell housing 101 is illustrated and other elements are omitted in FIG. 2.

For example, the jellyroll structure 102 includes a rolled anode foil, a rolled cathode foil and a rolled separator between the rolled anode foil and the rolled cathode foil. As for the detail of the jellyroll structure, please refer to relevant art.

As shown in FIG. 2, an opening 201 is created on a bottom side of the cell housing 101 and a copper plate 202 is forged with the cell housing 101 to form a bi-metal plate 203 (such as a cu-steel plate) on the bottom side of the cell housing 101, and the copper plate 202 is welded with the jellyroll structure 102.

In this disclosure, a laser is used to weld the copper plate 202 and the cell housing 101, but it is not limited thereto. For example, other ways such as an ultrasonic may be used in the welding process.

It should be appreciated that some components or elements are illustrated only as examples in FIG. 1 and FIG. 2. However, it is not limited thereto, for example, connections or positions of the components or elements may be adjusted, and/or, some components or elements may be omitted.

In some embodiments, the bi-metal plate 203 is formed to seal the opening 201, and the copper plate 202 is welded with the jellyroll structure 102 by using a laser via the opening 201 from outside of the cell housing 101. The shape/thickness of copper plate 202 can be adjusted by tooling on demand according to requirement.

Therefore, joining/welding the cell housing with the jellyroll structure is achieved by using a laser from outside of the cell housing, while risk of corrosion of cell housing is not introduced.

In some embodiments, one or more flattened tabs of the jellyroll structure are pre-welded with a copper current collector on a bottom side of the jellyroll structure, and the copper plate is welded with the copper current collector by using a laser after the jellyroll structure is inserted into the cell housing.

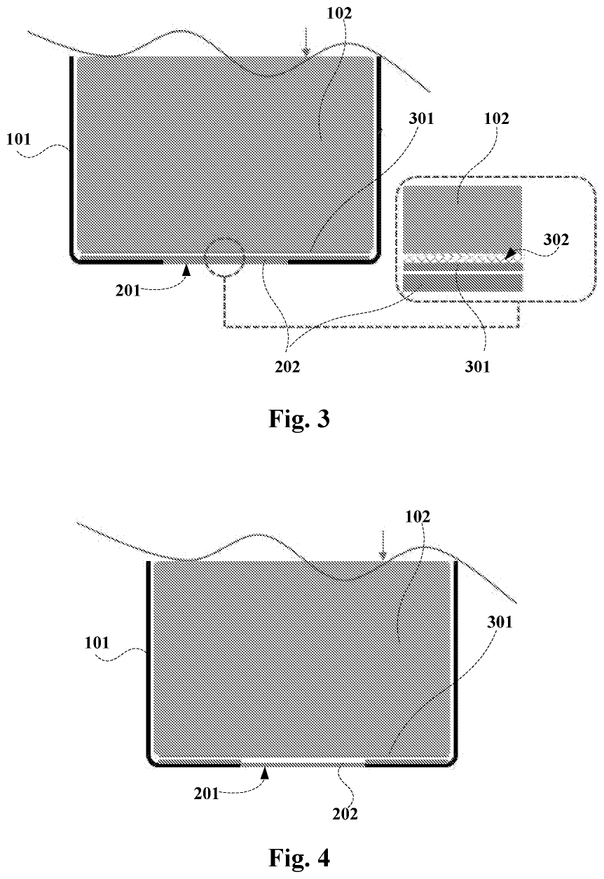

FIG. 3 is another diagram which shows a section view of the cylindrical battery cell in accordance with an embodiment of the present disclosure. As shown in FIG. 3, a copper current collector 301 is provided and there are one or more flattened tabs 302 in the jellyroll structure 102.

As shown in FIG. 3, the flattened tabs 302 of the jellyroll structure 102 are pre-welded with the copper current collector 301 on the bottom side of the jellyroll structure 102, and the copper plate 202 is welded with the copper current collector 301 by using a laser after the jellyroll structure 102 is inserted into the cell housing 101.

Therefore, the copper current collector is pre-welded to the flattened copper tabs. The cell housing (Cu) will be laser welded to the copper current collector (Cu) afterwards, such that there is not difference in melting point when welding.

In some embodiments, a thickness of the copper plate in the opening is larger than a thickness of the cell housing. For example, as shown in FIG. 3, the copper plate 202 is forged and through the opening 201, such that the thickness (D1) of the copper plate 202 in the opening 201 is larger than the thickness (D2) of the cell housing 101, that is D1>D2.

In some embodiments, a thickness of the copper plate in the opening is equal to a thickness of the cell housing, or the thickness of the copper plate in the opening is smaller than a predetermined threshold.

FIG. 4 is another diagram which shows a section view of the cylindrical battery cell 100 in accordance with an embodiment of the present disclosure. As shown in FIG. 4, a copper current collector 301 is provided on the bottom side of the jellyroll structure 102.

As shown in FIG. 4, the copper plate 202 is forged and through the opening 201, the thickness (D1) of the copper plate 202 in the opening 201 is equal to the thickness (D2) of the cell housing 101, or the thickness (D1) of the copper plate 202 in the opening 201 is smaller than a predetermined threshold (T1); that is D1=D2, or D1<T1.

Therefore, compared to FIG. 3, the structure in FIG. 4 has lower thickness and enables laser welding process with lower beam intensity, which in terms enhances the quality of laser welding process and reduces manufacturing cost.

In some embodiments, one or more flattened tabs of the jellyroll structure are welded with the copper plate by using a laser after the jellyroll structure is inserted into the cell housing. For example, there is not a pre-welded copper current collector.

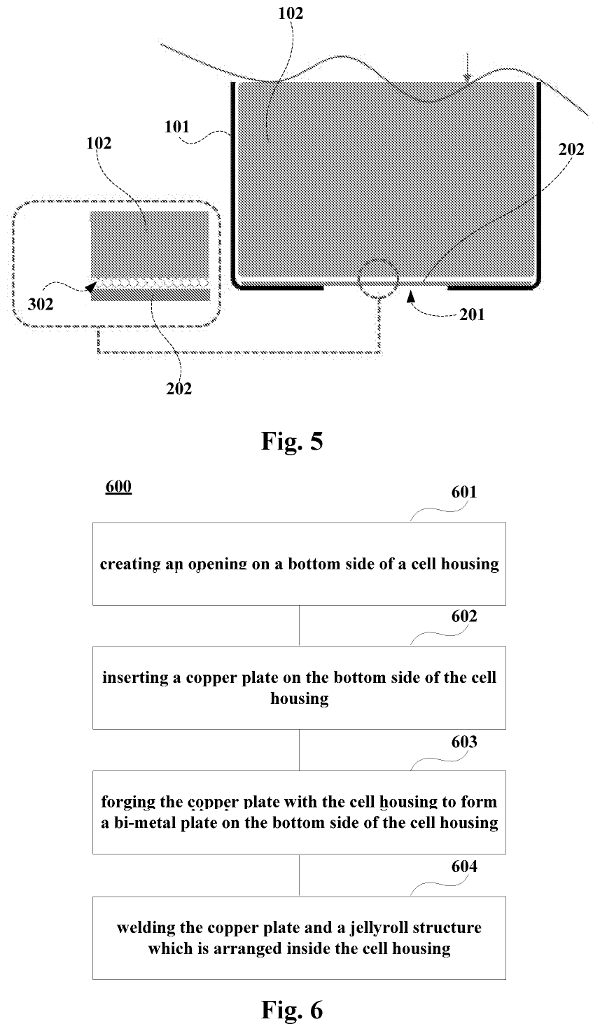

FIG. 5 is another diagram which shows a section view of the cylindrical battery cell 100 in accordance with an embodiment of the present disclosure. As shown in FIG. 5, there are one or more flattened tabs 302 in the jellyroll structure 102. The flattened tabs 302 of the jellyroll structure 102 are welded with the copper plate 202 by using a laser after the jellyroll structure 102 is inserted into the cell housing 101.

Therefore, the copper current collector is intendedly not considered in this example. The cell housing will be directly laser welded to the flattened copper tabs of the jellyroll structure. Consequently, one manufacturing process, welding current collector (Cu) to tabs is skipped, which reduces manufacturing costs.

In some embodiments, a thickness of the copper plate in the opening is equal to a thickness of the cell housing, or is smaller than a predetermined threshold. For example, D1=D2, and it is not limited thereto.

In some embodiments, the cell housing is made up of steel, and the bi-metal plate is formed by a forging process on the bottom side of the cell housing. However, it is not limited thereto.

It should be appreciated that some components or elements are illustrated only as examples in FIG. 3 to FIG. 5. However, it is not limited thereto, for example, connections or positions of the components or elements may be adjusted, and/or, some components or elements may be omitted.

In this disclosure, copper is configured in cell housing by a bi-metal forging process. For example, after deep drawing of a steel cell housing, an opening on the cell bottom is created by a punching/stamping process. Afterwards a copper plate is forged on the bottom side of the cell housing. The shape and thickness of the copper plate can be adjusted by tooling. Different shape and thickness of the copper plate may provide and enhance variety of cell properties, regarding thermal management and cooling system.

After inserting of the jellyroll structure into the cell housing, cell bottom (copper plate) can be penetration laser welded directly to the jellyroll structure, from outside of the cell housing. For example, the jellyroll structure can be pre-welded its own current collector (copper disk). For another example, it is possible to laser weld the copper plate directly to flattered tabs.

In this disclosure, joining of a copper plate to a steel cell housing by enabling laser welding from outside of the cell housing can be achieved, and the risk of corrosion within cell can be eliminated. Furthermore, the technique solution of this disclosure can maximize a space usage at the bottom side of the cell housing (higher volumetric filling ratio, higher energy content per cell, lower cost per cell mechanic).

In addition, the technical solution enhances substantially a thermal conduction path at the cell bottom. Concurrently, high in-plane thermal conduction of jellyroll structure (in vertical axis) is achieved, this enables implementation of bottom cooling at module/pack level.

For example, implementation of bottom cooling increases volumetric filling ratio at module/pack level by minimize 5%. Implementation of bottom cooling resolves many technical challenges in integration and reduces manufacturing costs.

It is to be understood that, the above examples or embodiments are discussed for illustration, rather than limitation. Those skilled in the art would appreciate that there may be many other embodiments or examples within the scope of the present disclosure.

It can be seen from the above embodiments, an opening is created on a bottom side of the cell housing and a copper plate is forged with the cell housing to form a bi-metal plate on the bottom side of the cell housing, and the copper plate is welded with the jellyroll structure. Therefore, joining/welding the cell housing with the jellyroll structure is achieved by using a laser from outside of the cell housing, while risk of corrosion of cell housing is not introduced.

### A Second Aspect of Embodiments

A method for forming cylindrical battery cell is provided in the embodiments. The corresponding devices are illustrated in the first aspect of embodiments, and the same contents as those in the first aspect of embodiments are omitted.

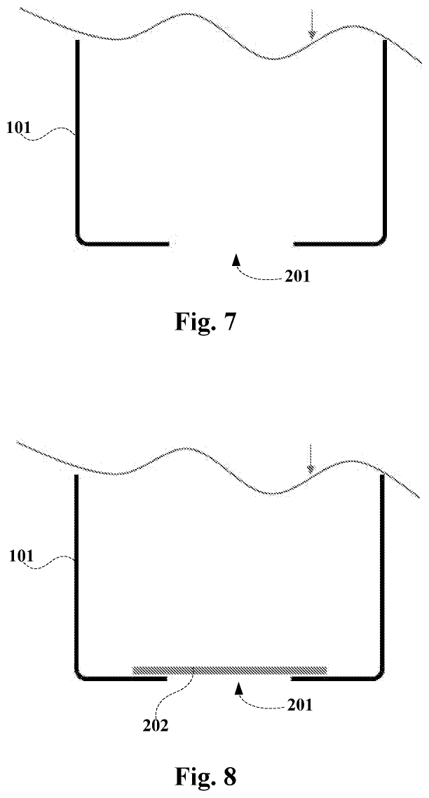

FIG. 6 is a diagram which shows a method for forming cylindrical battery cell in accordance with an embodiment of the present disclosure. As shown in FIG. 6, a method 600 for forming cylindrical battery cell includes:
601, creating an opening on a bottom side of a cell housing;
FIG. 7 is a diagram which shows a cell housing with an opening in accordance with an embodiment of the present disclosure. As shown in FIG. 7, an opening 201 can be created by stamping.

As shown in FIG. 6, a method 600 for forming cylindrical battery cell includes:
602, inserting a copper plate on the bottom side of the cell housing;
FIG. 8 is a diagram which shows a cell housing inserting a copper plate in accordance with an embodiment of the present disclosure. As shown in FIG. 8, a copper plate 202 can be inserted into the cell housing 101 and be configured to cover the opening 201.

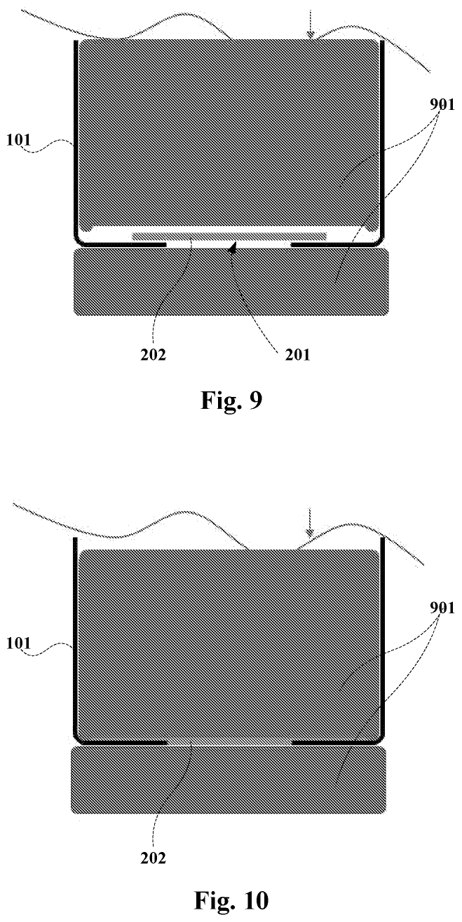

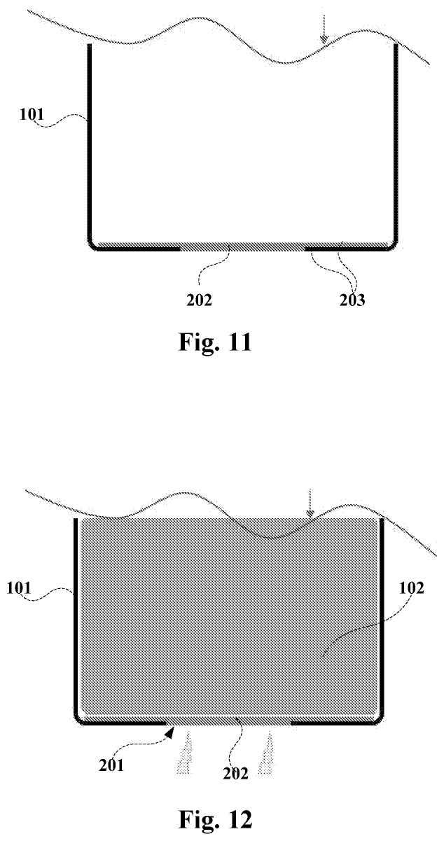

As shown in FIG. 6, a method 600 for forming cylindrical battery cell includes:
603, forging the copper plate with the cell housing to form a bi-metal plate on the bottom side of the cell housing;
FIG. 9 is a diagram which shows a cell housing forging a copper plate in accordance with an embodiment of the present disclosure; FIG. 10 is another diagram which shows a cell housing forging a copper plate in accordance with an embodiment of the present disclosure;
FIG. 11 is another diagram which shows a cell housing forging a copper plate in accordance with an embodiment of the present disclosure. As shown in FIG. 9, a forging machine 901 may be introduced. As shown in FIG. 10, a forging process is executed. As shown in FIG. 11, a bi-metal plate 203 is formed.

As shown in FIG. 6, a method 600 for forming cylindrical battery cell includes:
604, welding the copper plate and a jellyroll structure which is arranged inside the cell housing.

FIG. 12 is a diagram which shows a cell housing welding with a copper plate in accordance with an embodiment of the present disclosure. As shown in FIG. 12, the copper plate 202 is weld with the jellyroll structure 102 by using a laser via the opening 201.

It should be appreciated that FIG. 6 is only an example of the disclosure, but it is not limited thereto. For example, the order of operations at blocks or steps may be adjusted, and/or, some blocks or steps may be omitted. Moreover, some blocks or steps not shown in FIG. 6 may be added.

In some embodiments, the bi-metal plate is formed to seal (or cover) the opening, and the copper plate is welded with the jellyroll structure by using the laser from outside of the cell housing.

In some embodiments, one or more flattened tabs of the jellyroll structure are pre-welded with a copper current collector on a bottom side of the jellyroll structure, and the copper plate is welded with the copper current collector by using a laser after the jellyroll structure is inserted into the cell housing.

In some embodiments, a thickness of the copper plate in the opening is larger than a thickness of the cell housing.

In some embodiments, a thickness of the copper plate in the opening is equal to a thickness of the cell housing, or is smaller than a predetermined threshold.

In some embodiments, one or more flattened tabs of the jellyroll structure are welded with the copper plate by using a laser after the jellyroll structure is inserted into the cell housing.

In some embodiments, a thickness of the copper plate in the opening is equal to a thickness of the cell housing, or is smaller than a predetermined threshold.

In some embodiments, the cell housing is made up of steel, and the bi-metal plate is formed by using a forging process on the bottom side of the cell housing.

It can be seen from the above embodiments, an opening is created on a bottom side of the cell housing and a copper plate is forged with the cell housing to form a bi-metal plate on the bottom side of the cell housing, and the copper plate is welded with the jellyroll structure. Therefore, joining/welding the cell housing with the jellyroll structure is achieved by using a laser from outside of the cell housing, while risk of corrosion of cell housing is not introduced.

### A Third Aspect of Embodiments

A battery is provided in the embodiments. The corresponding devices and the method are illustrated in the first and second aspects of embodiments, and the same contents as those in the first and second aspects of embodiments are omitted.

In some embodiments, the battery includes a plurality of the cylindrical battery cell according to the first aspects of embodiments.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device.

While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous.

Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A cylindrical battery cell, at least comprising a cell housing and a jellyroll structure which is arranged inside the cell housing,
wherein an opening is created on a bottom side of the cell housing and a copper plate is forged with the cell housing to form a bi-metal plate on the bottom side of the cell housing, and the copper plate is welded with the jellyroll structure.

2. The cylindrical battery cell according to claim 1, wherein the bi-metal plate is formed to seal the opening, and the copper plate is welded with the jellyroll structure by using the laser via the opening from outside of the cell housing.

3. The cylindrical battery cell according to claim 1, wherein one or more flattened tabs of the jellyroll structure are pre-welded with a copper current collector on a bottom side of the jellyroll structure, and the copper plate is welded with the copper current collector by using a laser after the jellyroll structure is inserted into the cell housing.

4. The cylindrical battery cell according to claim 3, wherein a thickness of the copper plate in the opening is larger than a thickness of the cell housing.

5. The cylindrical battery cell according to claim 3, wherein a thickness of the copper plate in the opening is equal to a thickness of the cell housing, or is smaller than a predetermined threshold.

6. The cylindrical battery cell according to claim 1, wherein one or more flattened tabs of the jellyroll structure are welded with the copper plate by using a laser after the jellyroll structure is inserted into the cell housing.

7. The cylindrical battery cell according to claim 6, wherein a thickness of the copper plate in the opening is equal to a thickness of the cell housing, or is smaller than a predetermined threshold.

8. The cylindrical battery cell according to claim 1, wherein the cell housing is made up of steel, and the bi-metal plate is formed by using a forging process on the bottom side of the cell housing.

9. A method for forming cylindrical battery cell, comprising:
creating an opening on a bottom side of a cell housing;
inserting a copper plate on the bottom side of the cell housing;
forging the copper plate with the cell housing to form a bi-metal plate on the bottom side of the cell housing; and
welding the copper plate and a jellyroll structure which is arranged inside the cell housing.

10. The method according to claim 9, wherein the bi-metal plate is formed to seal the opening, and the copper plate is welded with the jellyroll structure by using the laser via the opening from outside of the cell housing.

11. The method according to claim 9, wherein one or more flattened tabs of the jellyroll structure are pre-welded with a copper current collector on a bottom side of the jellyroll structure, and the copper plate is welded with the copper current collector by using a laser after the jellyroll structure is inserted into the cell housing.

12. The method according to claim 11, wherein a thickness of the copper plate in the opening is larger than a thickness of the cell housing.

13. The method according to claim 11, wherein a thickness of the copper plate in the opening is equal to a thickness of the cell housing, or is smaller than a predetermined threshold.

14. The method according to claim 9, wherein one or more flattened tabs of the jellyroll structure are welded with the copper plate by using a laser after the jellyroll structure is inserted into the cell housing.

15. The method according to claim 14, wherein a thickness of the copper plate in the opening is equal to a thickness of the cell housing, or is smaller than a predetermined threshold.

16. The method according to claim 9, wherein the cell housing is made up of steel, and the bi-metal plate is formed by using a forging process on the bottom side of the cell housing.

17. A battery, comprising a plurality of cylindrical battery cells according to claim 14.

18. The battery according to claim 17, wherein the bi-metal plate is formed to seal the opening, and the copper plate is welded with the jellyroll structure by using the laser via the opening from outside of the cell housing.

19. The battery according to claim 17, wherein one or more flattened tabs of the jellyroll structure are pre-welded with a copper current collector on a bottom side of the jellyroll structure, and the copper plate is welded with the copper current collector by using a laser after the jellyroll structure is inserted into the cell housing.

20. The battery according to claim 19, wherein a thickness of the copper plate in the opening is larger than a thickness of the cell housing.
